(19) United States
(12) Patent Application Publication
(10) Pub. No.: US 2003/0200264 A1
(43) Pub. Date: Oct. 23, 2003

(54) Wireless email protocol system and method of using the same

(76) Inventor: Gregory M. Brill, Upper Saddle River, NJ (US)

Correspondence Address: Tony D. Alexander, TECHNOLOGY LEGAL COUNSEL LLC, POST OFFICE BOX 1728, EVANS, GA, 30809, US

(21) Appl. No.: 10/125,764

(22) Filed: Apr. 18, 2002

(51) Int. Cl. G06F 15/16

(52) U.S. Cl. 709/206; 709/249

(57) ABSTRACT

The method in accordance with the present invention allows any user to compose and transmit email messages using the resources native to the user's computer. In particular, the user can utilize a PDA as a wireless email antenna to transmit messages composed on an attached device, such as the user's laptop or desktop computer without having to directly connect to the Internet, thus providing mobile connectivity, personal resource accessibility and real-time PDA/PC synchronization.

### COPYRIGHT NOTICE

A portion of the disclosure of this patent document contains material that is subject to copyright protection. The copyright owner has no objection to the facsimile reproduction by anyone of the patent disclosures, as it appears in the Patent and Trademark Office patent files or records, but otherwise reserves all copyright rights whatsoever.

### FIELD OF THE INVENTION

This present invention pertains generally to information communications, and more particularly, devices and methods for flexible mobile access to email client services.

### BACKGROUND OF THE INVENTION

As the world becomes more mobile, the need for continuous access to information increases. As a result, Portable Digital Assistants (PDAs) have been developed to allow users to send and receive emails via some form of wireless protocol. Retrieval of email is often an awkward process when using these wireless devices. Wireless devices typically utilize proprietary application programming interfaces allowing retrieval of email from a single source, e.g., from their ISP, or in any event allow retrieval of mail from a single mail account. Some conventional applications offer “web-clipping” as a means of retrieving information and transmitting it to a wireless device. Therefore, the range of material accessible from a PDA is significantly limited.

Moreover, current email enabled PDAs do not allow a user to leverage the full complement of resources resident on their “home” computer (i.e., computer most often used to for daily tasks). Conventional PDAs, with their limited storage capacity are not suitable for storing large files. Moreover, most PDA's have scaled down versions of software applications that differ significantly from their personal computer (PC) counterparts. As a result, the functionality available to PDA users is substantially reduced. For example, the user may want the benefit of using Microsoft Outlook® or Microsoft Word®, as email editor, for spell check purposes. Alternatively, users may desire to retrieve files from their computer and include these files as email attachments. These and other desirable features are generally not available to PDA users.

Beyond the access limitations of these devices, PDAs are unsatisfactory alternatives to ones desktop or laptop computer for composing or reading lengthy emails or attachments. Few PDAs have onboard keyboards, and the few available keyboards are too small for effective use. Attempts have been made to address this limitation by providing external keyboards, however, these keyboards can be cumbersome and expensive.

Additionally, users desire a streamlined process for transmitting full feature messages while simultaneously synchronizing their PC and their personal digital assistant. To date, the synching function takes place after the email exchange and often requires user intervention. Moreover, users would like the freedom to compose full-featured email messages on, for example, a laptop computer and transmit these messages to its destination without having to locate and connect the laptop to a phone line. In short there is an existing need for a device, system and method that allows a user to bypass a direct internet connection by connecting their computer to a PDA configured to serve as a wireless antenna that routes full featured email and simultaneously synchronizes the devices.

There are significant efficiency and economic concerns with current mobile communication devices, and thus mobile communication devices and methods that combine the benefits of mobile connectivity with information resource accessibility are desirable. There remains an existing need for a system, device, and method of using the same, which gives users access to information residing on their computer and allowing the marshalling of these resources in a mobile environment.

### SUMMARY OF EXEMPLARY EMBODIMENTS

Solutions to the problems outlined above are proposed using a device, system and method of routing information. In particular, the present inventor has designed a novel method that allows users the ease of transmitting wireless email messages, with email enabled PDAs. In fact, the present invention provides for the composition of emails in a traditional email environment with the benefit of a mobile email transmission process that is seamlessly analogous to that of composing and transmitting messages and connecting to a standard email server. An advantage of an exemplary device, system and method of the present invention is that the user does not have to make a direct Internet connection and their PC and PDA are automatically synchronized when messages are sent and received.

While every PDA has some form of “synching” mechanism whereby the emails sent and received by the PDA are reconciled with the user's “regular” email, this always occurs after the fact, that is, after all such emails have already been sent and received using the PDA. Prior to the present invention, there was no way to actually send and received emails from an ordinary email program (e.g., Microsoft Outlook® or Eudora®) running on the user's laptop, and route it through an attached PDA. In this way, the user can use a PDA as an external email antenna allowing the user to send and receive email in an ordinary fashion wherever they are by simply “plugging” their laptop into their PDA.

A principle objective, in accordance with an exemplary embodiment of the present invention, is to provide a means of superseding a PDA's user interface with that of a full-featured email client-running on a user's everyday computer. In the furtherance of this and other objectives, the present inventor has developed an industry standard email server, which supports industry-standard POP3/SMTP protocols. This email server runs locally on a machine attached to the PDA and accepts and retrieves emails to and from the PDA to and from any email client supporting these protocols.

Still another objective of the present invention is to provide a means of avoiding the use of the PDA's built in miniature keyboard, which is awkward to use.

Yet another objective of the present invention is to provide devices, systems and methods that allow users to access the built-in features of the email client of their choice. By way of an illustrative example only, the user can, inter alia, use Microsoft Word® as their email editor, which allows them access to spell checking, a thesaurus, or the ability to cut-and-paste.

A further object of the present invention is to provide a communication device, system and method that affords users the ability to reference documents, files and/or other resources stored on their local hard drive or networked database environment in their email. In the furtherance of this and other objectives, a preferred embodiment provides a method of sending attachments with email messages.

An additional objective of the present invention is to provide a user the ability to compose email messages using a full-sized keyboard while still accessing the functionality of the PDA.

Still another objective of the present invention is to provide a means of allowing for real-time synchronization of a PDA with a PC. In the furtherance of this and other objectives, the PC and PDA are synchronized simultaneously with the transmission of out-going and incoming information.

The number and variability of applications, devices, systems and methods, in accordance with the present invention, are limited only by the imagination of the user.

Further objectives, features and advantages of the invention will be apparent from the following detailed description taken in conjunction with the accompanying drawings.

### BRIEF DESCRIPTION OF THE DRAWINGS OF PREFFERED EMBODIMENTS

FIG. 1 shows a schematic setup sequence diagram showing a configuration of the system in accordance with the present invention in the standard orientation.

FIG. 2 is a schematic diagram showing a PDA operatively coupled with a PC, via a coupler where the coupler is preferably a serial connection.

FIG. 3 is a schematic diagram showing a PDA daemon initiated on the PDA, of FIG. 2, for effective communication with the PC via the coupler.

FIG. 4 is a schematic diagram showing a PC daemon initiated on a PC, facilitating communication, via the coupler, between the PC and the PDA.

FIG. 5 is a schematic diagram showing the initiation of an email client on a PC.

FIG. 6 is a schematic diagram showing an email client receiving email from a PC daemon through a POP3 mailbox, from which the email client, through an SMTP connection, can send email to the PC daemon.

FIG. 7 is a schematic diagram showing a PDA receiving an email retrieved by the PDA daemon.

FIG. 8 is a schematic diagram showing a PDA daemon sending the contents of a received email to the PC daemon running on the PC, via a coupler.

FIG. 9 is a schematic diagram showing an email client retrieve email from a PC daemon via a POP3 mailbox after the PC daemon makes the received email available to email clients by putting it in the POP3 mailbox.

FIG. 10 is a schematic diagram showing the received email, of FIG. 9, available to the user of the email client.

FIG. 11 is a schematic diagram showing the email composition process in general and an email client's display of a composed email in particular.

FIG. 12 is a schematic diagram showing an email client sending email to a PC daemon via an SMTP connection.

FIG. 13 is a schematic diagram showing a PC daemon sending the email contents, of FIG. 12, to a PDA daemon via a coupler.

FIG. 14 is a schematic diagram showing a PDA daemon transmitting the email, of FIG. 12, to the desired recipient via the proprietary email service of the PDA.

### DETAILED DESCRIPTION OF THE PREFERRED EMBODIMENTS

The method in accordance with the present invention allows any user to compose and transmit email messages using the resources native to the user's computer. In particular, the user can utilize a PDA as a wireless email antenna to transmit messages composed on an attached device, such as the user's laptop or desktop computer without having to directly connect to the Internet, thus providing mobile connectivity, personal resource accessibility and real-time PDA/PC synchronization.

Applications for the invention also include other and applications that as of now are unidentified.

The following terms are used throughout this specification and should be construed in accordance with the following definitions and not inconsistent with their usage herein:

Application Program Interface Calls (API): An interface between the operation system and application programs, which includes the way the application programs communicate with the operating system, and the services the operating system makes available to the programs.

daemon: A program that runs and operates continuously in the background. Email servers are usually daemons.

Personal Digital Assistant (PDA): A pocket-sized PC. PDAs usually can store phone numbers, appointments, and to-do lists. Some PDAs have a small keyboard, while others have only a special pen that is used for input and output. A PDA can also have a wireless fax modem. Files can be created on a PDA, which are later entered into a larger computer.

Serial Protocol: A set of rules or standards designed so that computers can exchange data in serial form, one bit at a time, as opposed to a parallel interface which sends a number of bits side by side. Serial ports between computers (or a computer and a PDA) are normally connected via serial cables. Devices can communicate over these cables using a serial protocol.

Simple Mail Transfer Protocol/Post Office Protocol Version 3 (SMTP/POP3): Simple Mail Transfer Protocol is a server-to-server protocol for sending electronic mail. A server implementing SMTP acts as a gateway through which email may be sent from an email client. Post Office Protocol, version 3 is a protocol implemented by a host serving as a central repository where electronic mail is stored before the recipient downloads it; analogous to a U.S. Mail post office box where mail is stored waiting to be picked up. In an email address, the POP3 host is the part to the right of the @ symbol.

The present invention may be embodied in several forms, but in a preferred embodiment, a two-component solution is provided which comprises a small resident program running on a PDA and a special proprietary email server running on the laptop or desktop computer that is connected to the device. The email server is preferably a POP3/SMTP email server, which is unique in that, via industry standard protocols, it promiscuously communicates with all email clients.

A principal advantage of the device, system and method in accordance with the present invention is the ability to send and receive email without having to directly access the Internet, with the PC providing the information to be transmitted. In the furtherance of this and other objectives, a proprietary server sends and receives packets through the email daemon on the PDA via a coupler such as a serial cable. It would be apparent to one of ordinary skill in the art that a serial cable can connect a PDA to a PC for communication purposes. However, a proprietary serial protocol is provided that utilizes the coupler to allow the PDA to communicate with the proprietary SMTP/POP3-compatible email daemon. As a result, the daemon acts as a translator from the SMTP/POP3 communication requests it receives from an email client to the proprietary serial protocol used to communicate with the resident program running on the PDA.

The software installed on the PDA also implements the same proprietary serial protocol. It receives the translated proprietary request from the SMTP/POP3 email daemon to send or receive email messages. This software component then translates that request into the PDA's proprietary API calls that perform the actual requests. By translating email client requests for action into the PDA's API calls, new functionality not previously available to PDA users is made available: specifically, the user may access all of the features of any email client including spell checking, file attachments, cutting and pasting text, and any other services their email client may support. It is a key feature, of an exemplary embodiment, of the present system to provide an email server that implements SMTP/POP3 protocols that integrate with any email client and routes them through the PDA as opposed to the Internet. Since this solution can be employed with any available email client, the end-user has the choice of email clients, which heretofore was unavailable. The innovation resides, at least in party, in the two software programs that reside on the PDA and PC and cooperate to facilitate the email routing process. In view of the forgoing and the subsequent detailed description, a person of ordinary skill in the relevant programming art would be appraised of how to program an email server for a PC, a translator communication protocol and an email chaperone program for the PDA, which allows the PC user to send and receive full featured email messages from the PC via the proprietary email program native to the PDA; in short, using the PDA as a wireless email antenna for the PC email.

The set up and use of the present invention is straightforward and simple. Moreover, one of ordinary skill in the relevant art would be able to configure the present invention from the following discussion.

As discussed earlier, the present invention comprises a two-component solution, which comprises a small resident program running on a PDA and a special proprietary email server running on the laptop or desktop computer that is connected to the PDA. The small resident program is referred to hereinafter as the email harbinger program in that it helps to chaperone email from the email client on the PC to the recipient via the PDA's native email service. The email server is preferably a POP3/SMTP email server, which is unique in that, via industry standard protocols, it promiscuously communicates with all email clients (e.g., Microsoft Outlook®, Eudora® etc.). The user need only install the email harbinger program on the PDA and the email server on the PC or the devices could be shipped to the user preinstalled.

By connecting the PDA to the PC, via the coupler, which usually comes with the PDA, the user is able to communicate in a new manner. In particular, a coupler such as the PDA's serial cable is typically only used to synchronize names and addresses between a PDA and a PC. However, the present invention utilizes the serial cable in a novel manner, namely, allowing a PC user to bypass an Internet connection to send and receive email through their PDA.

An email server must be installed on the PC and a resident email harbinger program must be installed on the PDA. These proprietary components of the present invention can be installed by the user or may be preinstalled on the devices prior to shipping to the user. The user must then configure the email client application (Microsoft Outlook, Eudora, Lotus mail, anything that is POP/SMTP industry standard compliant) to reference the IP address of the email server. Since the email server is running on the PC, the address of “local host” may always be used.

Once installed and configured, the user need only connect the PC and PDA via the serial connector that comes standard with the PDA, run their email applications, and send and receive email normally. However, behind the scenes, the proprietary software, in accordance with the present invention, controls the sending and receiving of email as follows:

The email application sends email to the proprietary POP/SMTP email server and the proprietary email server receives the email in SMTP format. The email server contacts the email harbinger program on the PDA, and sends email to the email harbinger program, through the coupler, using a proprietary translator communication protocol. The email harbinger program, on the PDA, gets email content, sends requests from the email server; and sends email through the PDA's native email service. This allows the transmission of email from a PC, preferably a laptop, without the need to first access the Internet.

The process is similar when receiving emails. The PDA gets the email and the email harbinger program notifies the email server, via the coupler, that newly received email has arrived. Through the coupler, the email server retrieves email from the email harbinger program using the proprietary translator communication protocol. The email server stores email(s) locally on the PC. The user's Email application “polls” (periodically checks) the email server at an interval specified to the email client application by the user (this is standard behavior for POP3 email servers and clients to interact—POP email servers expect to be polled). The email server responds to email client polling on the laptop and gives email to the email client via the industry standard POP protocol.

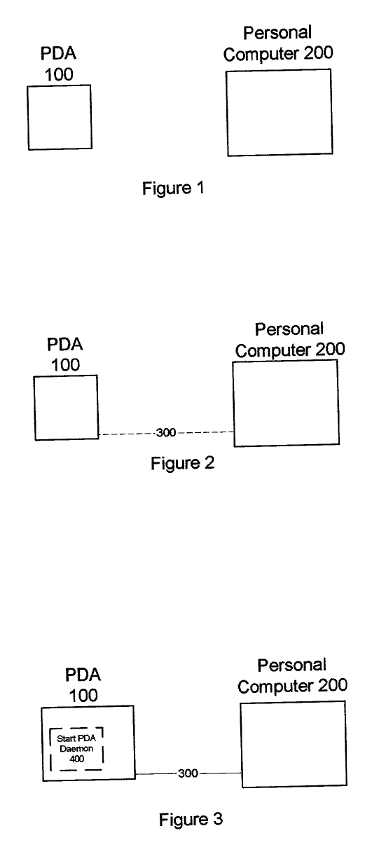

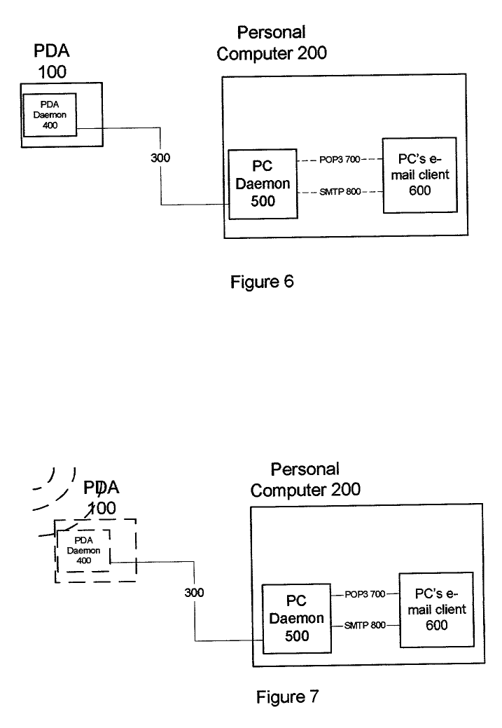

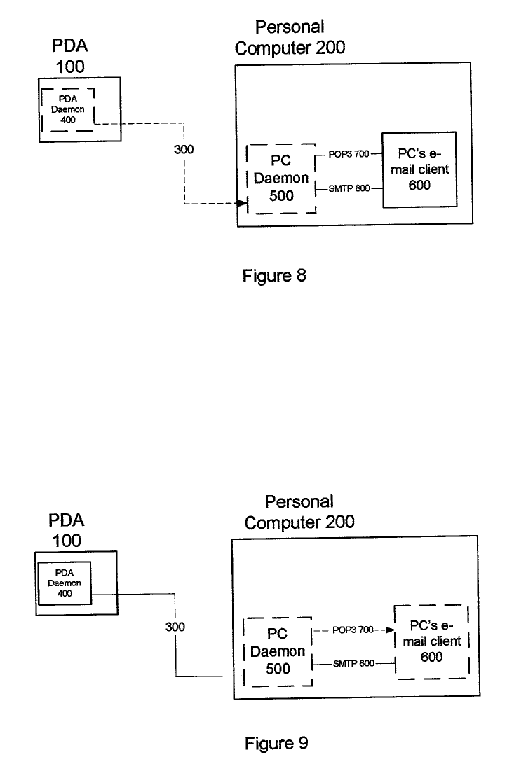

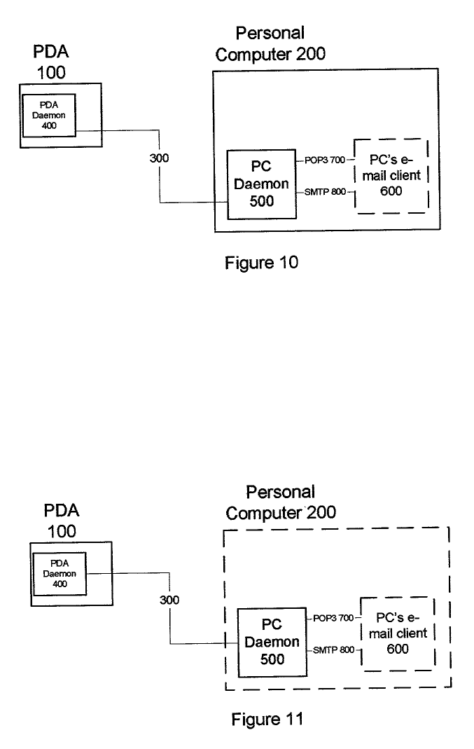

Turning now to the figures, where like numbers refer to like components, we see a device, system and method of mobile email composition and delivery that provides users with a range of functionality previously unavailable. In particular, FIGS. 1-10 show the process of receiving emails on a PC through the PDA native email service. FIG. 1 shows a schematic setup sequence diagram showing a configuration of the system in accordance with the present invention in the standard orientation.

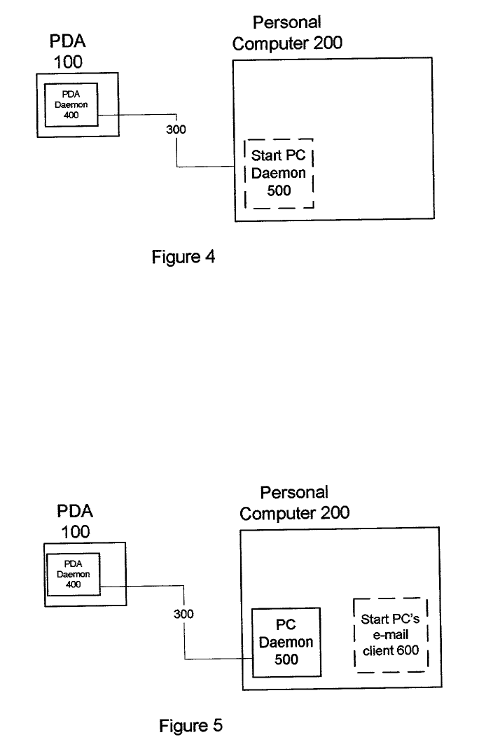

In particular, referring now to FIG. 2, the PDA 100 is operatively coupled with a PC 200, via a coupler 300 where the coupler 300 is preferably a serial connection. Both the PDA daemon 400 and the PC daemon 500 are in the background. Referring to FIGS. 3 and 4, a PDA daemon 400 process is started on the PDA 100, and can then effectively communicate with PDA 100 and coupler 300. The PC daemon 500 process is started on the PC 200. Then PC daemon 500 can communicate with the PDA 100 through coupler 300. PC daemon 500 also sets up a POP3 mailbox, and a SMTP service for communication with email clients.

Referring to FIGS. 5-10, an email client 600 is started on the PC 200. The email client 600 can receive email from PC daemon 500 through a POP3 mailbox 700. Email Client 600 can send email to PC daemon 500 through the SMTP Connection 800. When PDA 100 receives email, PDA daemon 400 retrieves it and sends the contents of the received email, via the coupler 300, to PC daemon 500, which is running on PC 200. PC daemon 500 then makes the received email available to email clients by putting the email in a POP3 mailbox 700. The email Client 600 then retrieves the received email from PC daemon 500 via POP3 mailbox 700 and makes the received email available to the user of email client 600.

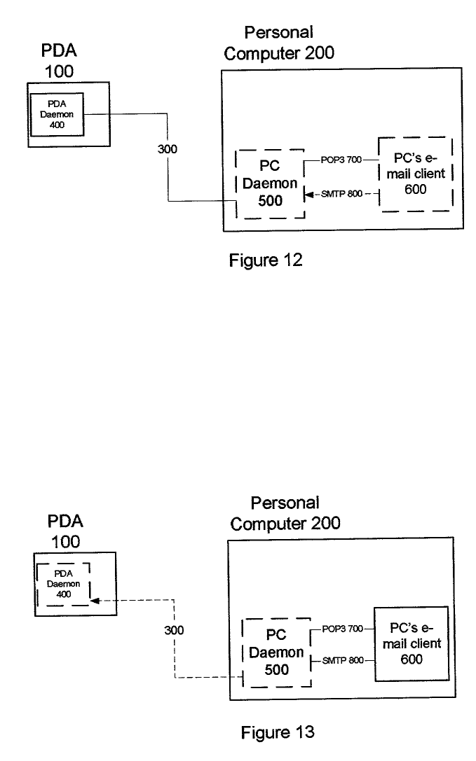

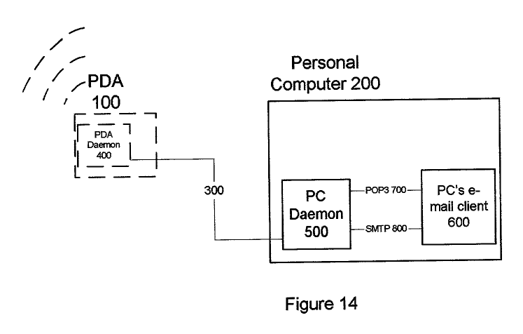

When a user composes and transmits email, the present invention, in a preferred embodiment, executes the sending process without the need to make a connection between the PC and the Internet. Referring to FIGS. 11-14, the email client 600 has an email composed. The email client 600 sends the email to PC daemon 500 via SMTP Connection 800. PC daemon 500 sends the contents of the email to PDA daemon 400, via coupler 300. PDA daemon 400 then transmits the email to the desired recipient, via the PDA 100's proprietary email service.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes, which come within the meaning and range of equivalency of the claims, are to be embraced within their scope.

What is claimed is:

1. A method of providing streamlined email communication to and from a computing device such as a laptop or a desktop computer through email capabilities native to a serially connected personal digital assistant, the method comprising the steps of:
providing a communication request using resources resident on a computing device;
receiving, via an email daemon, the communication request from the application resident on the computing device;
translating the communication request to a serial protocol; and
commanding the personal digital assistant to send composed email and retrieve received email through the personal digital assistant's native email capabilities.

2. The method of claim 1, wherein the serial protocol allows contemporaneous client communication routing and synchronization between the computing device and the personal digital assistant.

3. The method of claim 1, wherein the resident resource is an email client application.

4. The method of claim 3, wherein the serial protocol performs the transmitting step without first accessing the Internet.

5. The method of claim 4, wherein the communications request is an email message.

6. The method of claim 5, wherein the computing device is a laptop personal computer.

7. A system for allowing a user to engage in incoming and outgoing email communications on a personal computer without having to make a direct internet connection, the system comprising:
a personal computer having an email server with a unique IP address and an email client application operationally installed thereon, the email client application configured to reference the IP address of the email server;
a personal digital assistant having an email harbinger program and a native email program installed thereon; and
a coupler between the personal computer and the personal digital assistant, which employs a translator communication protocol;
whereby the user of the personal computer can send and receive email messages to and from the personal computer by using the personal digital assistant as a wireless email antenna.

8. The system of claim 7, wherein the email client application is compliant with the industry standard.

9. The system of claim 8, wherein the email client application is POP/SMTP compliant.

10. The system of claim 9, wherein the POP/SMTP compliant email client application is selected from the group consisting of Microsoft Outlook, Outlook Express, Entourage, Eudora, and Lotus Mail.

11. The system of claim 9, wherein the email application is configured to send email to the POP/SMTP email server in SMTP format.

12. The system of claim 11, wherein the email server is communicatively connected with the email harbinger program resident on the personal digital assistant, via the coupler, the email harbinger program configured to obtain email content, send requests from the email server and send email through the email program native to the personal digital assistant.

13. The system of claim 11, wherein the personal digital assistant gets email and the email harbinger program notifies the email server resident on the personal computer of newly received email via the coupler.

14. The system of claim 13, wherein the email server retrieves email from the email harbinger program, via the coupler, through the use of the translator communication protocol.

15. The system of claim 14, wherein email logs of the personal computer and the personal digital assistant are synchronized as the email is transmitted between the personal computer and the personal digital assistant.

16. The system of claim 14, wherein the email server stores email(s) locally on the personal computer.

17. The system of claim 14, wherein the email application periodically checks the email server at an interval specified to the email client application and the email server responds to email client polling on the personal computer.

18. A translator communication protocol that allows a personal digital assistant, operatively coupled with a personal computer, to serve as an antenna for chaperoning email communications to and from the personal computer.

19. An email server configured to cooperate with any POP/SMTP compliant email client to send and receive email messages through a serially connected personal digital assistant.

20. The email server of claim 19, wherein the email messages are sent without first establishing an Internet connection.

21. An email harbinger program for installation on a personal digital assistant, the email harbinger program configured to obtain email content, send requests from an email server and send email through an email service native to the personal digital assistant.

22. The email harbinger program of claim 21, wherein the email server is not resident on the personal digital assistant.

23. The email harbinger program of claim 22, wherein the email server is communicably coupled with the harbinger program via a coupler.

24. An article of manufacture comprising a computer-readable medium having stored thereon instructions adapted to be executed by a processor, the instructions which, when executed, define a series of steps to control a user's ability to route personal computer generated information through a personal digital assistant, the personal digital assistant serving as a mobile wireless antenna for transmission to a communications network, said steps comprising:
receiving incoming information from the client server in accordance with a client control protocol;
sending outgoing information to the client server in accordance with the client server protocol.
routing the incoming and outgoing information to and from the client server and the personal computer; and
synchronizing the incoming and out-going information, automatically, between the personal digital assistant and the personal computer.

25. A method for communicating information from one client, with a first computer to at least one other client, having a computer, the method comprising: (a) transmitting information, by the first computer through a personal digital assistant, based on interaction by the personal digital assistant and the at least one other client computer; (b) receiving, through the personal digital assistant, information from the at least one other client; and (c) periodically repeating steps (a) and (b) to synchronize the information between the personal digital assistant and the first computer.

26. A communication device, comprising: a first connection means for transmitting/receiving data to/from a first electronic device which has a storage unit having at least communication information stored therein in accordance with a first system; a second connection means for transmitting/receiving data to/from client email server; a communication control instruction reception means for receiving communication control instructions sent from the client email server; a first communication information synchronization means for synchronizing communication information between the first electronic device and the communication device, the data received via the first connection means; and a communication means for performing communication between the client email server and other electric devices included in a communication network.

27. A method of receiving email on a personal computer, transmitted through a personal digital assistant as mobile antenna, without having to first establish an Internet connection, the method comprising the steps of:
providing a personal computer, the personal computer having an email server with a unique IP address and an email client application operationally installed thereon, the email client application configured to reference the IP address of the email server;
providing a personal digital assistant having an email harbinger program and a native email program installed thereon;
providing a coupler between the personal computer and the personal digital assistant, which employs a translator communication protocol;
starting a daemon process on the personal digital assistant, creating an effectively communicate between the personal digital assistant daemon and the coupler;
starting a daemon process on the personal computer, creating an effective communication between the personal computer daemon and the personal digital assistant through the coupler;
setting up, by the personal computer daemon, of a POP3 mailbox and a SMTP service for communication with email clients;
starting an email client on the personal computer;
receiving email, by the email client, from the personal computer daemon through the POP3 mailbox;
sending email, by the email client, to the personal computer daemon, through the SMTP Connection.
receiving email, by the personal digital assistant, retrieved by the personal digital assistant daemon.
sending to the personal computer daemon, via the personal digital assistant daemon, the contents of the received email and making the contents of the email available to the email client by putting the email in the POP3 mailbox; and
accessing the email, by the user, from the email client.

28. A method of sending an email from a personal computer, transmitted through a personal digital assistant as mobile antenna, without having to first establish an Internet connection, the method comprising the steps of:
providing a personal computer, the personal computer having an email server with a unique IP address and an email client application operationally installed thereon, the email client application configured to reference the IP address of the email server;
providing a personal digital assistant having an email harbinger program and a native email program installed thereon;
providing a coupler between the personal computer and the personal digital assistant, which employs a translator communication protocol;
starting a daemon process on the personal digital assistant, creating an effectively communicate between the personal digital assistant daemon and the coupler;
starting a daemon process on the personal computer, creating an effective communication between the personal computer daemon and the personal digital assistant through the coupler;
setting up, by the personal computer daemon, of a POP3 mailbox and a SMTP service for communication with email clients;
providing a composed email message in an email client;
sending the email to a personal computer daemon via an SMTP connection;
sending, via the personal computer daemon, the contents of the email to the personal digital assistant daemon, via a coupler.
transmitting, via the personal digital assistant diamond daemon, the email to the desired recipient, via the personal digital assistant's proprietary email service.
